(19) United States
(12) Patent Application Publication
(10) Pub. No.: US 2025/0384542 A1
(43) Pub. Date: Dec. 18, 2025

(54) LEARNING DEVICE AND INSPECTION DEVICE

(71) Applicant: Panasonic Intellectual Property Management Co., Ltd., Osaka (JP)

(72) Inventors: MASATO TAYAMOTO, Osaka (JP); YOSHIRO KITAMURA, Osaka (JP); MASAHIRO MORI, Osaka (JP); DAIKI IMOTO, Hyogo (JP)

(21) Appl. No.: 19/313,848

(22) Filed: Aug. 28, 2025

Related U.S. Application Data
(63) Continuation of application No. PCT/JP2024/007117, filed on Feb. 27, 2024.

(30) Foreign Application Priority Data
Mar. 24, 2023 (JP) 2023-047973

(51) Int. Cl. G06T 7/00; G06T 7/62; G06V 10/141; G06V 10/22; G06V 10/26; G06V 10/60

(52) U.S. Cl. CPC G06T 7/0004; G06T 7/62; G06V 10/141; G06V 10/225; G06V 10/267; G06V 10/60

(57) ABSTRACT

A learning device that constructs, by machine learning, an image recognizer used for inspection of a welding state by image recognition of a workpiece to be processed in laser welding, includes: an image acquisition unit that acquires an image photographed by irradiating the workpiece with light having an infrared wavelength, the image including a region of a molten pool generated by phase transformation of the workpiece from solid to liquid during processing; an image processor that sets a boundary line between an inspection region and another region in the image based on luminance of the image; and a learning unit that constructs the image recognizer by machine learning to identify the inspection region in the image.

### TECHNICAL FIELD

The present disclosure relates to a learning device that performs machine learning of an image recognizer for inspecting a welding state by image recognition of a workpiece to be processed in laser welding, and an inspection device that inspects the welding state of the workpiece using the learned image recognizer.

### BACKGROUND ART

In recent years, there is an increasing demand in industry for performing measurement regarding a welding state, welding quality, or the like by in-process monitoring of laser welding. Examples of such measurement include a method of determining a welding state by monitoring, by a sensor light receiver, return light from a workpiece generated by reflection at a processing point at the time of laser processing. In this method, intensity of return light is measured, and from the intensity, for example, welding quality or the like is evaluated so as to grasp a qualitative molten state.

In addition, there has been reported a method of detecting, by optical coherence tomography (OCT), the depth of a keyhole generated in a portion irradiated with a laser beam in a workpiece at the time of laser welding. This method is used, for example, to quantify the depth of the keyhole separately from the surface abnormality of the workpiece.

In addition, there has also been devised a method of inspecting welding quality from images of a welded portion and a portion near the welded portion using an imaging device such as a CCD camera (for example, PTL 1). In the inspection method of PTL 1, based on a pattern of a luminance value in an image captured by reflected light of laser light from a metal object to be welded, that is, self-light, the welding quality is determined according to whether a correlation coefficient between the pattern and a reference pattern exceeds a predetermined threshold value.

### CITATION LIST

### Patent Literature

PTL 1: Unexamined Japanese Patent Publication No. 2005-111538

### SUMMARY OF THE INVENTION

An object of the present disclosure is to provide a learning device and an inspection device capable of accurately inspecting a welding state.

A learning device according to one aspect of the present disclosure constructs, by machine learning, an image recognizer used for inspection of a welding state by image recognition of a workpiece to be processed in laser welding. A learning device includes an image acquisition unit that acquires an image photographed by irradiating the workpiece with light having an infrared wavelength, the image including a region of a molten pool generated by phase transformation of the workpiece from solid to liquid during processing, an image processor that sets a boundary line between an inspection region and another region in the image based on luminance of the image, and a learning unit that constructs the image recognizer by machine learning to identify the inspection region in the image. In the image, the inspection region indicates at least one of a region of the molten pool, and regions formed inside or near the molten pool on the workpiece by the laser welding. The learning unit generates the image recognizer based on training data including the image and identification information for identifying the inspection region and another region by the boundary line in the image, in association with each other.

An inspection device according to one aspect of the present disclosure inspects a welding state of a workpiece to be processed in laser welding. An inspection device includes an image acquisition unit that acquires an image photographed by irradiating the workpiece with light of an infrared wavelength, the image including a region of a molten pool generated by phase transformation of the workpiece from solid to liquid during processing, an image recognizer that identifies an inspection region and another region in the image by image recognition of the image, and an inspection unit that calculates an inspection value quantitatively indicating a welding state in the inspection region based on a recognition result by the image recognizer. In the image, the inspection region indicates at least one of a region of the molten pool, and regions formed inside or near the molten pool on the workpiece by the laser welding. The image recognizer is generated by machine learning based on training data including a training image photographed under a photographing condition same as the image, and identification information for identifying the inspection region and another region in the training image, in association with each other, and the identification information is given by a boundary line set between the inspection region and another region in the training image.

The learning device and the inspection device according to the present disclosure can accurately inspect the welding state.

### BRIEF DESCRIPTION OF THE DRAWINGS

FIG. 1 is a diagram illustrating a configuration example of a welding system according to a first exemplary embodiment of the present disclosure.

FIG. 2A is a block diagram illustrating a configuration of a learning device and an inspection device according to the welding system of the first exemplary embodiment.

FIG. 2B is a block diagram illustrating a configuration of the learning device and the inspection device according to the welding system of the first exemplary embodiment.

FIG. 3 is a flowchart indicating an operation of the learning device according to the first exemplary embodiment.

FIG. 4 is a diagram for describing an image including a characteristic shape of a molten pool according to the welding system of the first exemplary embodiment.

FIG. 5A is a diagram for describing a luminance profile of a molten pool image according to the learning device of the first exemplary embodiment.

FIG. 5B is a diagram for describing the luminance profile of the molten pool image according to the learning device of the first exemplary embodiment.

FIG. 6 is a diagram for describing setting of a boundary line by a plurality of luminance profiles according to the learning device of the first exemplary embodiment.

FIG. 7 is a diagram for describing luminance profile interpolation processing using a front-rear frame image according to the learning device of the first exemplary embodiment.

FIG. 8A is a diagram for describing an inspection region of the molten pool image according to the first exemplary embodiment.

FIG. 8B is a diagram for describing the inspection region of the molten pool image according to the first exemplary embodiment.

FIG. 9 is a diagram for describing setting of a boundary line by luminance profiles different from those in FIG. 6 according to the learning device of the first exemplary embodiment.

FIG. 10 is a flowchart indicating an operation of the inspection device according to the welding system of the first exemplary embodiment.

FIG. 11A is a diagram for describing processing of determining a welding state by a time-series change in inspection values for a time-series continuous image into which the inspection region is classified according to the inspection device of the first exemplary embodiment.

FIG. 11B is a diagram for describing the processing of determining the welding state by a time-series change in the inspection values for the time-series continuous image into which the inspection region is classified according to the inspection device of the first exemplary embodiment.

FIG. 12 is a flowchart indicating processing of optimizing a control parameter corresponding to a processing condition of laser welding according to the inspection device of the first exemplary embodiment.

FIG. 13 is a diagram illustrating an experimental plan table at the time of processing according to the welding system of the first exemplary embodiment.

### DESCRIPTION OF EMBODIMENT

### Background to Present Disclosure

For example, as in PTL 1 described above, it is conceivable to quantify an area and/or a dimension of a molten portion of a workpiece caused by laser welding based on a change in luminance value or the like in an image obtained by photographing self-light at a processing point at the time of laser welding using a camera, and use a result of the quantification for inspection of a welding state or the like. For example, in a metal workpiece, a molten pool, which is a region where a temperature reaches a melting point or higher due to the heating by laser light causing melting and phase transformation from solid to liquid, is formed as the molten portion caused by laser welding. In the molten pool, for example, the reflectance changes due to melting, and the luminance value of the corresponding region in the image may be different from other regions on the workpiece.

Here, there is a case where it is difficult to accurately identify the molten pool in the self-luminous image caused by the reflection of the laser light described above. In this case, it is difficult to grasp the entire aspect of the molten pool in the image, and there is a possibility that phenomena such as hole formation and humping, which are defective phenomena occurring after the molten pool solidifies, are overlooked. Furthermore, in addition to the molten pool, it is conceivable to quantify an area and/or a dimension of the keyhole that can be an index of the welding state from the image photographed including the keyhole, and use the quantified area and/or dimension for inspection of the welding state. However, as described above, in the self-luminous image, there is a case where it is difficult to identify the region of the molten pool and/or the keyhole from other regions, and there is a concern that it is difficult to perform the quantification thereof with high accuracy.

As a method of clearly visualizing the molten pool at the time of laser welding, there is a method of irradiating the vicinity of a processing point with light of an infrared (IR) wavelength instead of the self-light described above, and putting a bandpass filter corresponding to the wavelength in an imaging device such as a camera to perform imaging. As a result, a very clear image of the molten pool and the periphery thereof can be obtained. However, in the image obtained by this method, for example, since all the peripheral portions other than the processing point are visualized in gray scale or color, it may be difficult to extract only a region near the keyhole and/or the molten pool to be quantified by binarization processing and/or edge detection.

Therefore, for an image including the molten pool captured under illumination of the IR wavelength, a method of detecting a region to be quantified, such as a molten pool, in an image in which the region is unknown, using a machine learning model for region classification obtained by machine learning such as deep learning, is conceivable. Such a machine learning model is obtained by, for example, setting labels for identifying a desired region in all pixels in an image and performing machine learning so as to output the label for each pixel based on a luminance value or the like of the image.

In the method using machine learning described above, it is necessary to create in advance teacher data called mask data in which labels are set for a plurality of regions in units of pixels in each image. The mask data is often created by a human hand, and it is generally known that how to set a boundary portion between regions in the mask data greatly affects the accuracy of region classification by the machine learning model.

An object of the present disclosure is to provide a method capable of automatically setting a boundary between regions for mask data so as to accurately classify regions such as a molten pool by a machine learning model in the image as described above. Here, in the present disclosure, depending on the type of a workpiece member that is a workpiece of laser welding, the reflectance of the IR wavelength may vary and the brightness or appearance of the molten pool in the image of the molten pool using illumination of the IR wavelength may vary.

For example, a member with a relatively high absorption rate with respect to the IR wavelength (for example, the reflectance of light having an IR wavelength is less than 90%) such as an iron plate appears dark on the image, and the region of the molten pool near the irradiation point of the laser light appears to have higher luminance than the surrounding region. On the other hand, in a member with a reflectance of light having an IR wavelength of 90% or more, such as aluminum or copper, the member itself looks bright, and the molten pool looks relatively dark. The present disclosure provides a method capable of similarly setting a boundary with high accuracy in an image using IR illumination even for workpiece members having a reflectance of the IR wavelength different depending on the type or surface accuracy of such members.

In order to achieve the object described above, the method of the present disclosure acquires luminance profiles (to be described later) having a line shape crossing the inside and the outside of a molten pool from a luminance value of an image including the molten pool at the time of laser welding, and refers to a rate of change in luminance to set a highly accurate boundary line for a region. As a result, mask data including a highly accurate region boundary can be created. For example, by learning the machine learning model of the region classification based on the raw data which is unprocessed image data and the mask data which is the teacher data, it is possible to perform the region classification with high accuracy in units of pixels as compared with a case where the above-described processing of setting the boundary line is not performed.

Hereinafter, an exemplary embodiment of the present disclosure will be described in detail with reference to the drawings. Note that the present invention is not limited to the following exemplary embodiment. In addition, modifications can be made as appropriate without departing from the scope within which an effect of the present disclosure is exhibited. Furthermore, combinations with other exemplary embodiments are also possible.

### First Exemplary Embodiment

In a first exemplary embodiment, a welding system including a learning device that sets, on an image, a boundary of a region regarding a welding state by the method of the present disclosure and learns a machine learning model of region classification and an inspection device that executes inspection of the welding state using the learned machine learning model, will be described.

### 1. Configuration

### 1-1. Configuration of Welding System

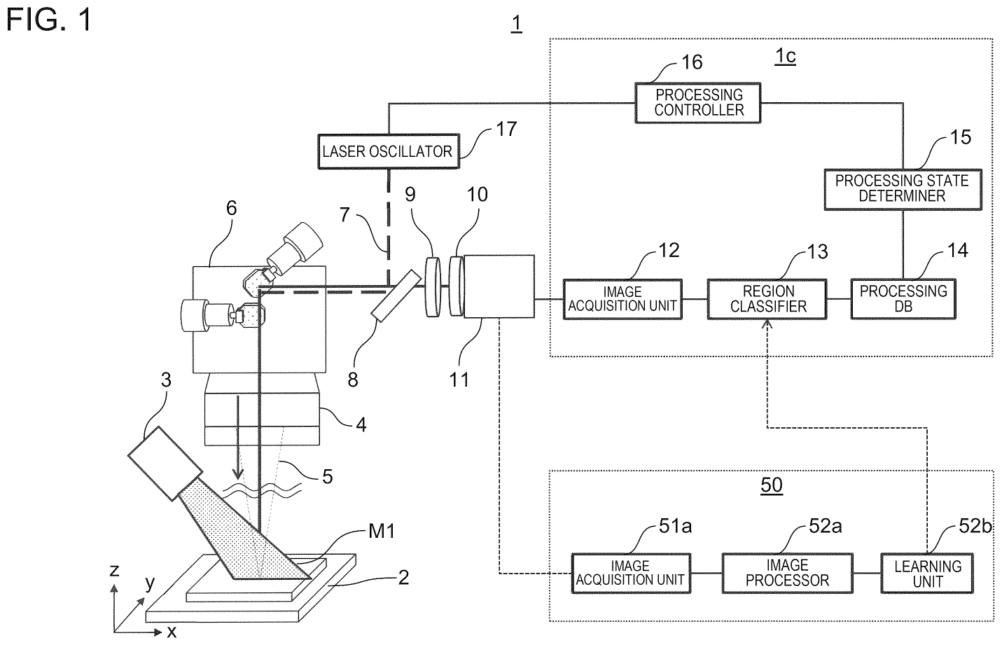

FIG. 1 illustrates a configuration example of welding system 1 according to the first exemplary embodiment of the present disclosure. Welding system 1 of FIG. 1 includes, for example, IR illumination 3, high-speed camera 11, inspection device 1c, and learning device 50 in addition to laser oscillator 17 and optical systems 4, 6, 8 to 10 constituting a laser processing machine. Inspection device 1c of the present exemplary embodiment constitutes, for example, a control system that controls the laser processing machine according to an inspection result.

Welding system 1 irradiates workpiece M1 disposed on processing stage 2 with laser light to perform welding processing of workpiece M1. For example, in a case where the material of workpiece M1 is iron, the thickness is 0.3 millimeters (mm), and the wavelength 2 of the laser light is 1070 nanometers (nm), a member with an absorption rate of the laser light of 40% and a melting point of 1700 Kelvin (K) is used. Processing stage 2 is movable in, for example, three directions (x, y, z) orthogonal to each other. For example, as processing stage 2, an XYZ stage having strokes of 200 millimeters (mm), 200 mm, and 50 mm in the respective directions is used. In addition, for example, workpiece M1 and processing stage 2 are overlapped and fixed by a fixing member (not illustrated).

Laser oscillator 17 emits a beam for forming laser light 7 by laser oscillation. Laser light 7 is substantially parallel light of the beam emitted by laser oscillator 17. For example, laser oscillator 17 is a continuous oscillation single mode fiber laser capable of performing laser oscillation with wavelength λ of 1070 nm.

Processing controller 16 controls various parameters of the laser processing machine. Processing controller 16 controls, according to processing conditions, a laser output, a beam diameter, a scanning speed, a profile shape, and the like in laser welding as such control parameters, for example.

In welding system 1, regarding laser light 7 from laser oscillator 17, an optical axis direction is rotated by 90° by folding mirror 8 and further reflected by galvano scanner 6, and thus laser light 7 is condensed on workpiece M1 by fθ lens 4. In workpiece M1, a molten pool is formed by heating with laser light 7 emitted from laser oscillator 17.

For example, folding mirror 8 reflects 90% or more of light having a wavelength of 1070 nm and transmits 80% or more of light having a wavelength of 400 nm to 700 nm, which is a visible light region, in return light 5 reflected from a laser processing point on workpiece M1. For example, galvano scanner 6 includes two mirrors that are rotatable about axes orthogonal to each other and a drive unit that rotates each mirror so as to be in a predetermined angle, and can scan laser light 7 on workpiece M1. Galvano scanner 6 of the present example reflects 90% or more of light in a wavelength band of 400 nm to 1070 nm. fθ lens 4 is a scanning lens, and has, for example, a corresponding wavelength of 1070 nm, a focal length of 255 mm, and a scanning range of 200 mm×200 mm.

IR illumination 3 emits light of an infrared (IR) wavelength. In present system 1, IR illumination 3 is fixedly installed so as to illuminate the vicinity of the processing point of workpiece M1 at a slant angle of 45° with respect to the surface of workpiece M1 irradiated with laser light 7. In IR illumination 3 of the present example, a wavelength of 850 nm, which is a wavelength band that avoids the wavelength bands of laser light 7 and return light 5, is used.

Condenser lens 9 is a plano-convex lens having a focal length f of 400 mm corresponding to a wavelength band of 400 nm to 700 nm which is the visible light region. Bandpass filter 10 shields light having a wavelength band other than a wavelength band corresponding to the wavelength of IR illumination 3 (850 nm in the present example).

High-speed camera 11 is an imaging device capable of continuously capturing images at high speed. In high-speed camera 11 of the present example, the sensor size is 7 mm×5 mm and the frame rate is 10,000 frames per second (fps).

Return light 5 generated from workpiece M1 is reflected by galvano scanner 6, transmitted through folding mirror 8, and then condensed on a sensor unit of high-speed camera 11 via condenser lens 9 and bandpass filter 10. For example, high-speed camera 11 is installed coaxially with the laser light and the field of view of the camera is also scanned in synchronization with the scanning of laser light 7 by galvano scanner 6, and thus high-speed camera 11 can photograph during the scanning while putting the molten pool in the same angle of view. High-speed camera 11 captures an image of a region including the molten pool on workpiece M1 at the time of welding as described above, and outputs image data indicating the captured image to an external device such as inspection device 1c or learning device 50. In present system 1, high-speed camera 11, inspection device 1c, and learning device 50 are configured to be able to perform data communication with each other.

In addition to processing controller 16 described above, inspection device 1c according to the present exemplary embodiment includes image acquisition unit 12, region classifier 13, processing database 14, and processing state determiner 15. Hereinafter, the database is abbreviated as “DB”.

For example, image acquisition unit 12 performs data communication with high-speed camera 11 to acquire image data from high-speed camera 11.

Region classifier 13 includes a machine learning model for region classification in the image. In present system 1, for example, region classifier 13 is generated by using machine learning such as deep learning in learning device 50 as described later and is acquired by inspection device 1c. Region classifier 13 of the present exemplary embodiment is an example of an image recognizer used to inspect a welding state by image recognition in a molten pool image of workpiece M1.

For example, the machine learning model of region classifier 13 includes a neural network including a plurality of convolution layers and pooling layers, and outputs a result of region classification in an input image with an image captured by the high-speed camera 11 as an input. For example, a rectified linear unit (ReLU) is used as an activation function of each layer. Region classifier 13 applies convolution processing and pooling processing to the input image to extract a feature amount from the image and down-sample the image. Thereafter, region classifier 13 up-samples the image again, and generates an image indicating a result of the region classification (hereinafter, also referred to as a “region classification image”) with a size similar to the size of the input image. As the final output function, for example, a sigmoid function is used.

In addition to the processing described above, region classifier 13 may perform, for example, processing of dividing the time-series continuous image captured by high-speed camera 11 for each frame and inputting the divided images. Furthermore, for example, region classifier 13 may output image data of the region classification image for each input image to processing DB 14.

For example, processing state determiner 15 calculates an inspection value indicating features regarding a welding state of each region such as an area and/or a dimension of the region classified as a region such as the molten pool based on the region classification image by region classifier 13. In addition, processing state determiner 15 determines various welding states such as a processing state of the molten pool based on the inspection value calculated for each image captured in time series.

For example, processing DB 14 stores the control parameters such as the laser output, the beam diameter, the scanning speed, and the profile shape corresponding to processing conditions by the laser processing machine, and the inspection values calculated from the time-series region classification images. In inspection device 1c of the present exemplary embodiment, as will be described later, the control parameters of each processing condition in a plurality of processing conditions and the time-series inspection values based on a captured image when welding processing is performed under each processing condition are accumulated in processing DB 14 in association with each other.

In the present exemplary embodiment, processing state determiner 15 further performs multi-objective optimization in which the control parameters of the processing conditions accumulated in processing DB 14 are set as an input and the inspection values under each processing condition are set as an output, so as to determine an optimal processing condition in a predetermined criterion such as the stability of laser welding. For example, processing state determiner 15 feeds back the control parameters of the determined processing condition to processing controller 16. The operation of inspection device 1c will be described later in detail.

In addition, in welding system 1 illustrated in FIG. 1, learning device 50 includes image acquisition unit 51a, image processor 52a, and learning unit 52b. For example, image acquisition unit 51a acquires image data of an image including the molten pool captured by high-speed camera 11 similarly to image acquisition unit 12 of inspection device 1c. As will be described later, image processor 52a sets a boundary between a predetermined region such as a molten pool and other region in the acquired image, and generates mask data of the predetermined region. For example, learning unit 52b generates region classifier 13 by machine learning based on training data including the captured images at the time of processing under various processing conditions and mask data generated from each captured image.

### 1-2. Configuration of Learning Device and Inspection Device

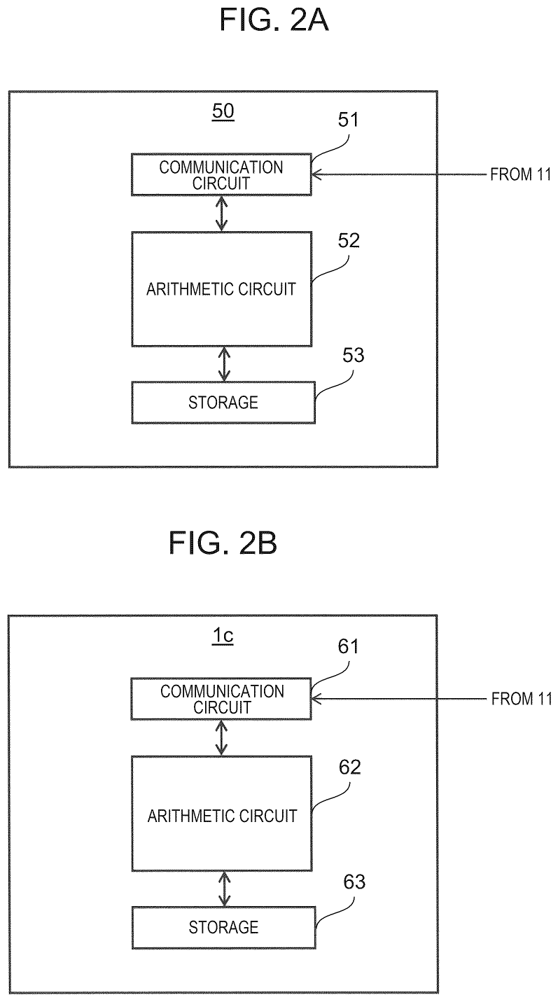

The configurations of learning device 50 and inspection device 1c in welding system 1 described above will be further described with reference to FIG. 2.

FIGS. 2A and 2B are block diagrams illustrating the configurations of learning device 50 and inspection device 1c according to welding system 1 of the present exemplary embodiment. FIG. 2A illustrates the configuration of learning device 50. For example, learning device 50 is implemented by, for example, various computers. Learning device 50 of FIG. 2A includes communication circuit 51, arithmetic circuit 52, and storage 53.

Communication circuit 51 is a circuit that performs communication in accordance with various standards such as IEEE802.11, Wi-Fi (registered trademark), 4G, or 5G. Communication circuit 51 is connectable to a communication network such as the Internet. Learning device 50 may communicate with another device through an access point via communication circuit 51, or may directly communicate with another device. Communication circuit 51 may perform wired communication in accordance with a standard such as Ethernet (registered trademark) and/or USB. In addition, communication circuit 51 may include a connection terminal (for example, video input terminal) for various types of wired communication capable of data transmission. For example, learning device 50 performs data communication with high-speed camera 11 and inspection device 1c via communication circuit 51. In learning device 50 of the present exemplary embodiment, image acquisition unit 51a is implemented by communication circuit 51.

Arithmetic circuit 52 is a circuit that performs various arithmetic processing, and executes, for example, a program stored in storage 53 to implement the function of learning device 50. Arithmetic circuit 52 includes, for example, one or more processors such as a CPU and/or a GPU. In the present exemplary embodiment, arithmetic circuit 52 functions as image processor 52a and learning unit 52b of learning device 50.

Arithmetic circuit 52 may be a hardware circuit such as a dedicated electronic circuit or a reconfigurable electronic circuit designed to implement the functions described above, or may be various semiconductor integrated circuits such as a GPGPU, a TPU, a DSP, a microcomputer, an FPGA, and an ASIC.

Storage 53 is a storage medium that stores a program and data, and stores, for example, a program executed by arithmetic circuit 52 described above, training data of the machine learning model that implements region classifier 13, the learned model after learning of the model, and the like. Storage 53 is configured as, for example, a magnetic storage such as a hard disk drive (HDD), an optical storage such as an optical disk drive, or a semiconductor storage device such as a solid state drive (SSD). Storage 53 may include a temporary storage element configured by a RAM such as a DRAM or an SRAM, or may function as an internal memory of arithmetic circuit 52. The program described above may be acquired from the outside of learning device 50 through the network via communication circuit 51.

### 1-3. Configuration of Inspection Device

FIG. 2B illustrates the configuration of inspection device 1c. In welding system 1 of the present exemplary embodiment, for example, inspection device 1c is configured by various computers similarly to learning device 50 described above, and includes communication circuit 61, arithmetic circuit 62, and storage 63.

In inspection device 1c, communication circuit 61 constitutes image acquisition unit 12. In addition, in inspection device 1c of present system 1, for example, the learned model constituting region classifier 13 is acquired from learning device 50 via communication circuit 61 and stored in storage 63. For example, arithmetic circuit 62 implements the function of inspection device 1c by executing the program stored in storage 63 or based on the learned model stored in storage 63. In the present exemplary embodiment, arithmetic circuit 62 of inspection device 1c constitutes region classifier 13 integrally with the learned model, and also functions as processing state determiner 15 and processing controller 16. Storage 63 stores various data, programs, and the like. For example, processing DB 14 includes storage 63.

### 2. Operation

The operation of welding system 1 configured as described above will be described below.

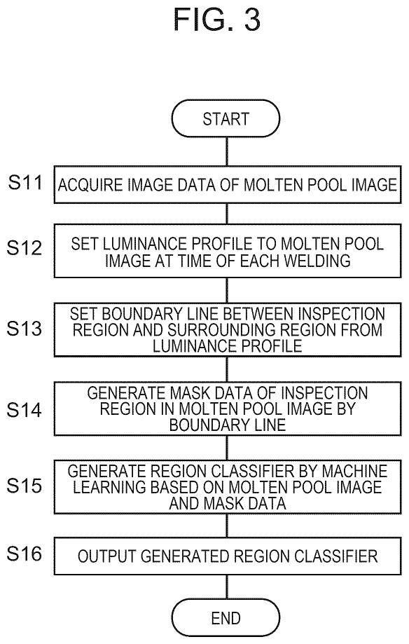

In welding system 1 of the present exemplary embodiment, learning device 50 sets a boundary between regions in the image from high-speed camera 11 to generate mask data as teacher data of region classification, and generates region classifier 13 by machine learning using the mask data. First, the operation of learning device 50 will be described with reference to FIGS. 3 to 9.

### 2-1. Operation of Learning Device

FIG. 3 is a flowchart indicating the operation of learning device 50. Each piece of processing in the flowchart of FIG. 3 is executed by, for example, arithmetic circuit 52 of learning device 50. The processing in this flowchart is started in a state where, for example, processing controller 16 performs laser welding while changing the control parameters under a plurality of processing conditions and high-speed camera 11 captures an image of workpiece M1 at the time of welding under each processing condition.

First, arithmetic circuit 52 acquires image data, which is captured by high-speed camera 11, by communication circuit 51 functioning as image acquisition unit 51a (S11). For example, high-speed camera 11 captures images in time series so as to include the molten pool during welding on workpiece M1 for each processing condition. In step S11, for example, the image data of an image including the molten pool (also referred to as a “molten pool image”) at the time of each welding is acquired. For example, arithmetic circuit 52 divides the acquired time-series image data at the time of each welding into frame images and performs the following processing of steps S12 to S14.

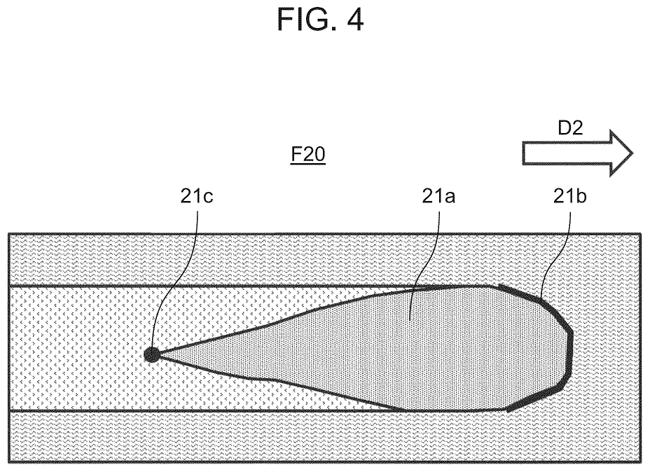

FIG. 4 illustrates the molten pool image of one frame in the image data acquired in step S11. FIG. 4 is a diagram for describing an image including a characteristic shape of the molten pool according to welding system 1 of the first exemplary embodiment. Frame image F20 of FIG. 4 includes molten pool region 21a corresponding to molten pool 21 formed on workpiece M1. Molten pool region 21a includes arc-shaped boundary 21b between an unprocessed region at a front side of workpiece M1 in scanning direction D2 of laser light 7. In addition, molten pool region 21a includes a wedge-shaped tail at a rear portion of workpiece M1 in scanning direction D2, and includes a singular point boundary 21c at a tip portion of the tail.

Next, for example, arithmetic circuit 52, as image processor 52a, sets a plurality of luminance profiles for each frame image in the molten pool image at the time of each welding based on the image data acquired in step S11 (S12). Each luminance profile indicates a change in luminance for each pixel in the image. Image processor 52a sets each luminance profile so that a luminance change on a straight line crossing or traversing the image is indicated.

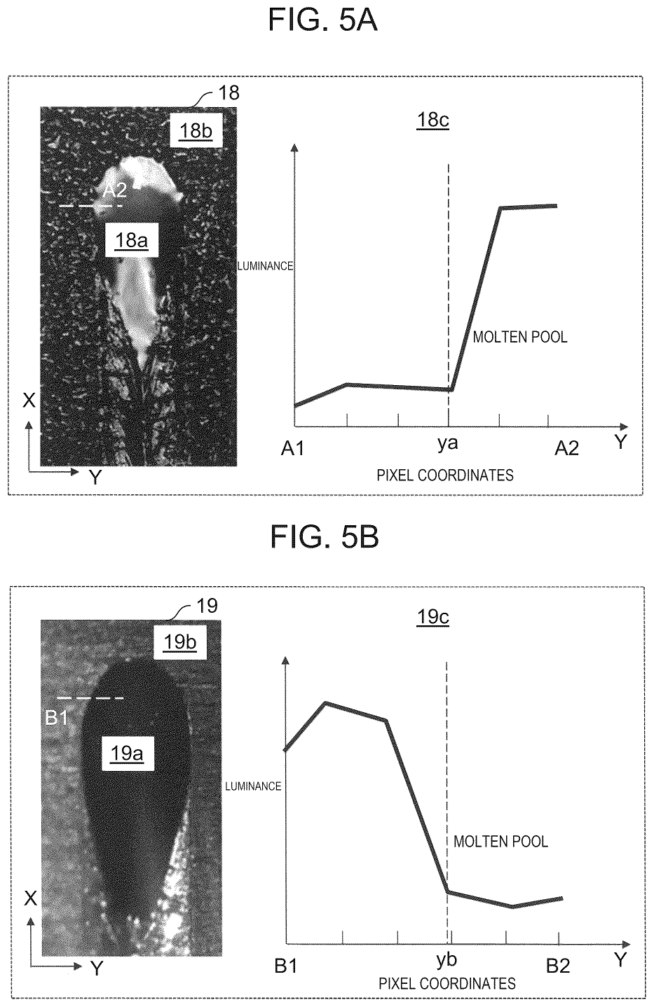

FIGS. 5A and 5B are diagrams for describing the luminance profile of the molten pool image in learning device 50 of the present exemplary embodiment. FIG. 5A illustrates molten pool image 18 and luminance profile 18c on straight line A1-A2 in molten pool image 18. Molten pool image 18 indicates an image captured at the time of welding workpiece M1 made of a material having low reflectance (for example, reflectance less than 70%) with respect to light of 850 nm which is a wavelength band of IR illumination 3. In such a low-reflectance member, in molten pool image 18, molten pool region 18a has higher luminance than surrounding unprocessed region 18b corresponding to the unprocessed region on workpiece M1.

In molten pool image 18, luminance profile 18c on straight line A1-A2 set to cross molten pool region 18a and unprocessed region 18b indicates a change in luminance according to pixel coordinates in a Y direction orthogonal to scanning direction D2 of laser light 7 with a horizontal axis representing pixel coordinates and a vertical axis representing luminance in FIG. 5A. In FIG. 5A, for example, pixel coordinate ya having a steep luminance change amount with respect to a change in pixel coordinate can be regarded as a boundary between molten pool region 18a and unprocessed region 18b.

FIG. 5B illustrates molten pool image 19 different from the example of FIG. 5A and luminance profile 19c on straight line B1-B2 in molten pool image 19. Molten pool image 19 indicates an image captured at the time of welding workpiece M1 made of a material having high reflectance (for example, reflectance higher than 90%) with respect to light in a wavelength band of IR illumination 3. In such a high-reflectance member, in molten pool image 19, molten pool region 19a has lower luminance than unprocessed region 19b.

In FIG. 5B, in molten pool image 19, luminance profile 19c on straight line B1-B2 set to cross molten pool region 19a and unprocessed region 19b indicates a change in luminance according to pixel coordinates in the Y direction with a horizontal axis representing pixel coordinates and a vertical axis representing luminance similarly to FIG. 5A. In the example of FIG. 5B, pixel coordinate yb having a steep luminance change amount with respect to a change in pixel coordinate can be regarded as a boundary between molten pool region 19a and unprocessed region 19b.

Arithmetic circuit 52 as image processor 52a sets a plurality of the luminance profiles described above in the molten pool image (S12), and sets a boundary line between the inspection region such as the molten pool region and other region from the set luminance profile (S13). The inspection region is a region that can be an inspection target by inspection device 1c in welding system 1.

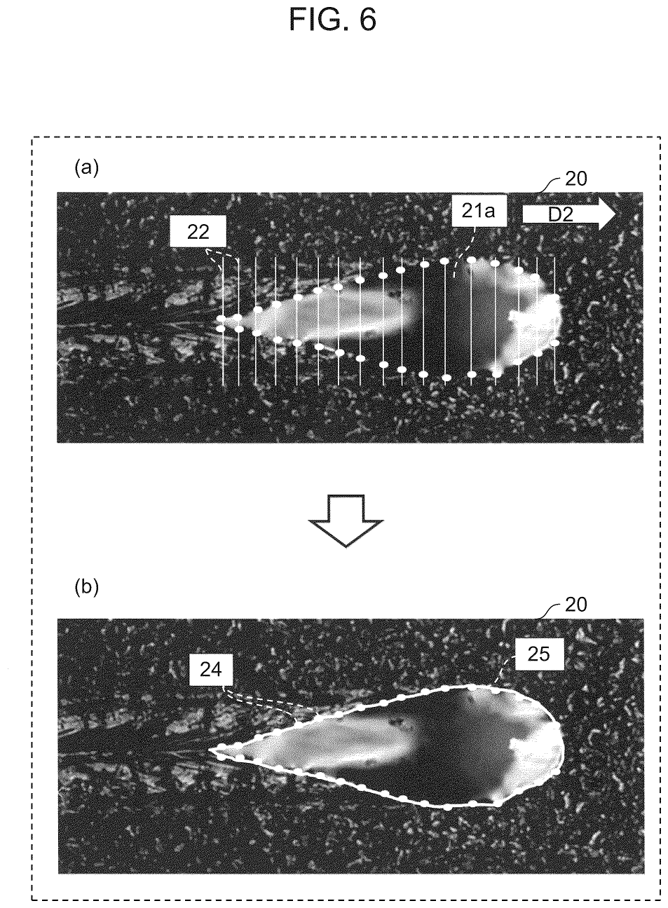

Parts (a) and (b) of FIG. 6 are diagrams for describing setting of a boundary line by the plurality of luminance profiles according to learning device 50 of the present exemplary embodiment. Parts (a) and (b) of FIG. 6 illustrate an example in which the boundary line between the molten pool region, as the inspection region, and the surrounding unprocessed region is set in molten pool image 20 captured similarly to molten pool image 18 of FIG. 5A. Part (a) of FIG. 6 illustrates an example in which, in molten pool image 20, a plurality of luminance profiles 22 is disposed at predetermined intervals in a direction perpendicular to molten pool region 21a with respect to scanning direction D2 of laser light 7.

In each luminance profile 22, image processor 52a determines, as a boundary between molten pool region 21a and the unprocessed region, for example, a boundary between pixels in which a change amount of luminance values with respect to a change in pixel coordinates is a predetermined value or more (S13). Image processor 52a sets a boundary line between molten pool region 21a and the unprocessed region from the pixel coordinates of the boundary determined by each luminance profile 22 (S13). Part (b) of FIG. 6 illustrates a plurality of points 24 indicating the boundary determined from respective luminance profiles 22 in part (a) of FIG. 6 and boundary line 25 interpolated so as to connect respective points 24 with a straight line, in molten pool image 20.

As a predetermined value for the change amount of the luminance values, for example, “20” experimentally confirmed to be able to determine the boundary is used. In addition, not only by the comparison between the predetermined value based on the absolute value and the luminance value, but also the boundary can be set if there is a change of 10% or more in the relative difference between the pixels in the luminance value according to, for example, photographing conditions by high-speed camera 11, the luminance distribution of the molten pool image, the setting of the desired welding intensity, or the like. According to the setting of the boundary using such a luminance profile, it is possible to accurately determine the boundary between molten pool region 21a and the unprocessed region while capturing characteristic shapes such as arc-shaped boundary 21b and singular point boundary 21c in the molten pool image (see FIG. 4).

Furthermore, in step S13, image processor 52a of the present exemplary embodiment performs luminance profile interpolation processing for accurately determining a boundary even in a case where it is difficult to determine a boundary in the molten pool image of one frame due to, for example, a change in a molten pool shape during welding.

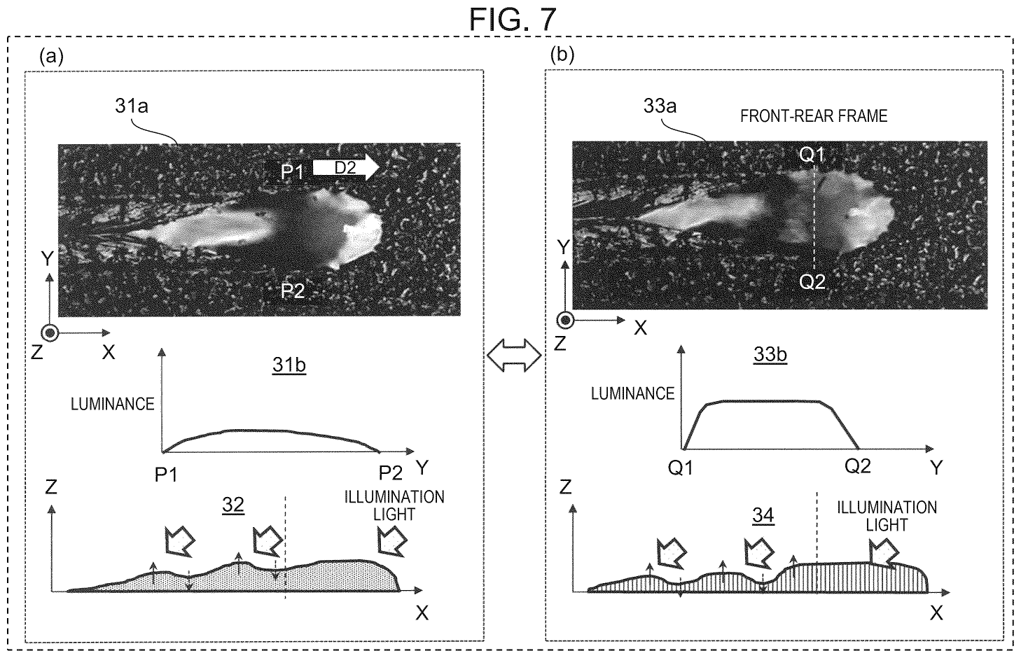

Parts (a) and (b) of FIG. 7 are diagrams for describing the luminance profile interpolation processing using a front-rear frame image according to learning device 50 of the present exemplary embodiment. Part (a) of FIG. 7 is an explanatory diagram of target image 31a, which is a frame image of a target for which the molten pool region is to be determined in step S13, and a luminance change in target image 31a. Part (b) of FIG. 7 is an explanatory diagram of front-rear target image 33a, which is a frame image before or after target image 31a, and a luminance change in front-rear target image 33a.

Together with luminance profile 31b on straight line P1-P2 in target image 31a, part (a) of FIG. 7 illustrates vibration diagram 32 indicating vibration of the surface of workpiece M1 when the molten pool of workpiece M1 is viewed in a cross-sectional view in a direction from P2 toward P1 of target image 31a at the time of capturing target image 31a. As illustrated in part (a) of FIG. 7, when the shape of the molten pool changes during welding of workpiece M1, the surface of workpiece M1 vibrates in the irradiation direction (Z direction in the drawing) of laser light 7, and a mountain portion having a raised shape and a valley portion having a recessed shape are generated on the surface. In the mountain portion of the molten pool, the light of IR illumination 3 is likely to be reflected and appears bright on a captured image, while in the valley portion, the light is less likely to be reflected and appears dark on the image.

For this reason, at the time of determining the boundary between the molten pool region and the unprocessed region by the luminance profile in each frame, for example, there may be a case where it is difficult to determine the boundary from the luminance profile since a portion including the boundary as on straight line P1-P2 of target image 31a is a valley portion and appears dark. Even in this case, in part (b) of FIG. 7, the boundary can be determined from luminance profile 33b on straight line Q1-Q2 in front-rear target image 33a at the time of welding in which the relevant portion is a mountain portion as illustrated in vibration diagram 34. As described above, for example, even if there is a portion where it is difficult to determine the boundary only with target image 31a, the boundary can be determined with high accuracy by performing interpolation using the front-rear frame image having a relatively large luminance change amount in the luminance profiles, such as front-rear target image 33a.

In the flowchart of FIG. 3, next, arithmetic circuit 52 as image processor 52a generates mask data of the inspection region as teacher data for generating region classifier 13 by machine learning based on the image data of the molten pool image in which the boundary line between the inspection region and other region is set (S14). For example, image processor 52a generates the mask data by labeling a region set in advance as a classification target by region classifier 13, such as the inspection region, for each pixel of the molten pool image (S14).

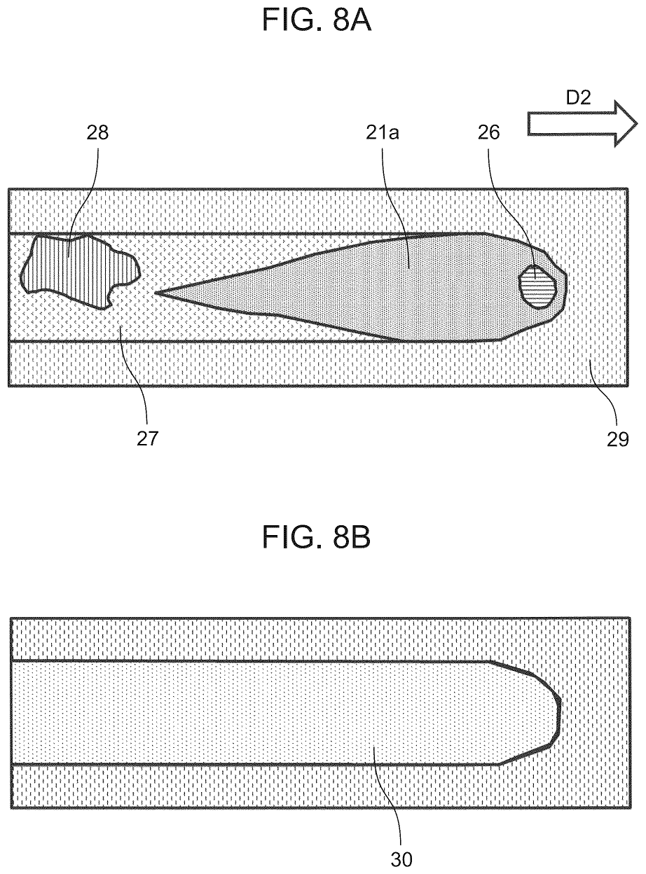

FIGS. 8A and 8B are diagrams for describing the inspection region of the molten pool image according to the present exemplary embodiment. FIG. 8A illustrates an example in which a region that can be an inspection region is shown in addition to molten pool region 21a in the molten pool image, for example. In workpiece M1, in a case where incident laser light 7 has a relatively high energy density, a keyhole is generated inside molten pool 21. In the molten pool image of FIG. 8A, since keyhole region 26 corresponding to such a keyhole exists inside molten pool region 21a and is a portion on workpiece M1 irradiated with laser light 7, the region has a very high luminance compared to the surrounding region.

For example, in a case where keyhole region 26 is classified as the inspection region, a plurality of luminance profiles is first set inside molten pool region 21a similarly to the processing of setting the boundary line between molten pool region 21a and unprocessed region 29 in steps S12 and S13. Then, in each luminance profile, for example, a boundary between pixels whose change in luminance is “50” or more with respect to a change in pixel coordinates can be determined as a boundary between keyhole region 26 and molten pool region 21a. In this case, a region in which the luminance value is larger by “50” or more than the surrounding region in molten pool region 21a is determined as keyhole region 26.

In addition, as illustrated in FIG. 8A, post-solidification bead region 27 exists in the molten pool image corresponding to the region generated at the rear portion of workpiece M1 in scanning direction D2 by the region of molten pool 21 passing through and being solidified by the scanning of laser light 7. Inside post-solidification bead region 27, there is perforated region 28 generated by forming a hole in workpiece M1 in relation to laser light 7 with high energy and the flow of the molten pool.

FIG. 8B illustrates, in the molten pool image of FIG. 8A, for example, molten region 30 within a boundary defined by horizontally extending an end point having the maximum diameter of the arc shape from arc-shaped boundary 21b of molten pool region 21a determined in steps S12 and S13 to an image end in scanning direction D2. For example, in the molten pool image, post-solidification bead region 27 is determined by taking a difference between molten pool region 21a where the boundary between the regions can be determined as described above, keyhole region 26, and unprocessed region 29 from molten region 30.

In addition, since the hole is formed in workpiece M1 and thus the light reflected by IR illumination 3 is less likely to return to high-speed camera 11, perforated region 28 is a very dark region in the molten pool image as compared with the surroundings. Therefore, in a case where perforated region 28 is set as the inspection region, the luminance profile is applied to the inside of post-solidification bead region 27, and the boundary between the pixels having the change in luminance of “50” or more with respect to the change in pixel coordinates can be determined as the boundary between post-solidification bead region 27 and perforated region 28. In this case, a region having a luminance value smaller by “50” or more than the surrounding region is determined as perforated region 28.

In step S14 of FIG. 3, image processor 52a may generate mask data including not only molten pool region 21a as the inspection region but also a part or all of keyhole region 26, post-solidification bead region 27, and perforated region 28 described above. In addition, the inspection region may include a region indicating spatter generated on workpiece M1. For example, for a molten pool image under each processing condition in a plurality of processing conditions, learning device 50 associates the mask data generated for each frame with an image of the frame, and accumulates the mask data in storage 53 as training data of region classifier 13.

Next, arithmetic circuit 52 performs, as learning unit 52b, for example, machine learning based on the training data of the molten pool image and the mask data, and generates region classifier 13 including the learned machine learning model, that is, the learned model (S15). Arithmetic circuit 52 may generate region classifier 13 further including various control programs and the like.

For example, arithmetic circuit 52 outputs generated region classifier 13 to storage 53 (S16), and ends the processing in this flowchart.

According to the above processing, by setting the plurality of luminance profiles in the molten pool image (S12) and setting the boundary line between the inspection region such as molten pool region 21a and other region from the luminance change in each luminance profile (S13), learning device 50 generates the mask data of the inspection region (S14). As a result, in the molten pool image, for example, a boundary line surrounding the inspection region such as molten pool region 21a that is difficult to extract by, for example, binarization processing and/or edge detection can be set with high accuracy, and highly accurate mask data can be obtained by labeling the region within the boundary line as the inspection region. Further, region classifier 13 including the learned model is generated by machine learning using the mask data obtained in this manner as teacher data of the region classification (S15).

According to region classifier 13 generated using the mask data of the inspection region as described above, the region classification for identifying the inspection region in the molten pool image can be implemented with high accuracy. This makes it possible to accurately inspect the welding state.

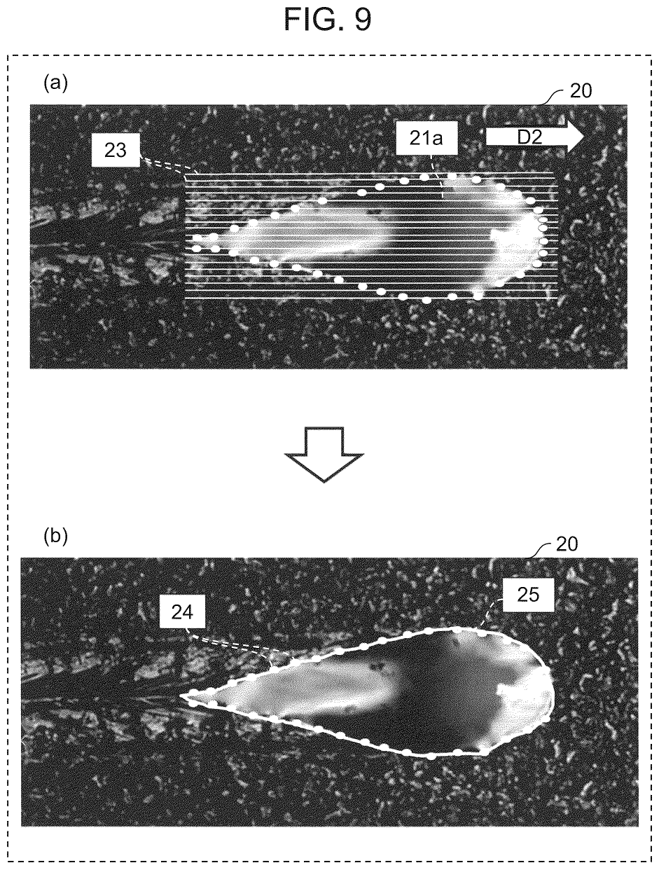

In steps S12 and S13 described above, the example of using the luminance profile in the direction perpendicular to scanning direction D2 of laser light 7 has been described (see FIGS. 5 and 6), but the luminance profile is not limited thereto. Parts (a) and (b) of FIG. 9 are diagrams for describing setting of a boundary line by luminance profiles different from those in parts (a) and (b) of FIG. 6 according to learning device 50 of the present exemplary embodiment. Part (a) of FIG. 9 illustrates an example in which a plurality of luminance profiles 23 is disposed on molten pool region 21a in the horizontal direction with respect to scanning direction D2 in molten pool image 20 similar to part (a) of FIG. 6 and part (b) of FIG. 6. Part (b) of FIG. 9 illustrates a plurality of points 24 indicating the boundary of molten pool region 21a determined from luminance profiles 23 in part (a) of FIG. 9 and boundary line 25 interpolated so as to connect respective points 24 with a straight line.

In the processing of steps S12 and S13, luminance profiles 23 horizontal to scanning direction D2 illustrated in FIG. 9 may be used instead of luminance profiles 22 set in the direction perpendicular to scanning direction D2. In addition, the boundary of the inspection region may be set using luminance profiles 22, 23 in both the vertical direction and the horizontal direction.

### 2-2. Operation of Inspection Device

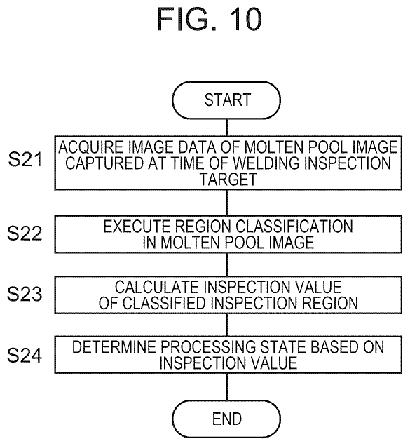

The operation of inspection device 1c using region classifier 13 generated as described above will be described with reference to FIGS. 10 to 13.

In welding system 1 of the present exemplary embodiment, inspection device 1c acquires region classifier 13 including the learned model generated from learning device 50 by communication circuit 61, for example, and inspects the welding state using the region classification result in the molten pool image in which the inspection region from high-speed camera 11 is unknown.

FIG. 10 is a flowchart indicating the operation of inspection device 1c according to welding system 1 of the present exemplary embodiment. The processing in this flowchart is started in a state where, for example, the learned model of region classifier 13 is stored in storage 63 in inspection device 1c, and the processing is executed by arithmetic circuit 62.

First, arithmetic circuit 62 of inspection device 1c acquires, from high-speed camera 11, image data of the molten pool image captured at the time of welding workpiece M1 to be inspected, for example, by communication circuit 61 functioning as image acquisition unit 12 (S21).

Next, by functioning as region classifier 13, arithmetic circuit 62 executes region classification using the learned model in the molten pool image indicated by the acquired image data (S22). Region classifier 13 classifies each pixel into a classification target region such as an inspection region for each frame of the molten pool image during welding based on the luminance value of the image data, for example.

Arithmetic circuit 62, as processing state determiner 15, calculates an inspection value quantitatively indicating the welding state in the classified inspection region from the region classification image in which the region classification is executed in the molten pool image (S23). In accordance with the inspection region to be classified, the inspection value includes, for example, a molten pool area indicating an area of molten pool region 21a, a keyhole area indicating an area of keyhole region 26, a bead width indicating a width of post-solidification bead region 27, and/or a molten pool tail length indicating a tail length of molten pool region 21a. The bead width may be calculated as, for example, the maximum length in a direction perpendicular to scanning direction D2. Processing state determiner 15 calculates such an inspection value that is a feature amount of each inspection region corresponding to the molten state in the region classification image of each frame, and stores the inspection values quantified in time series in processing DB 14 of storage 63, for example.

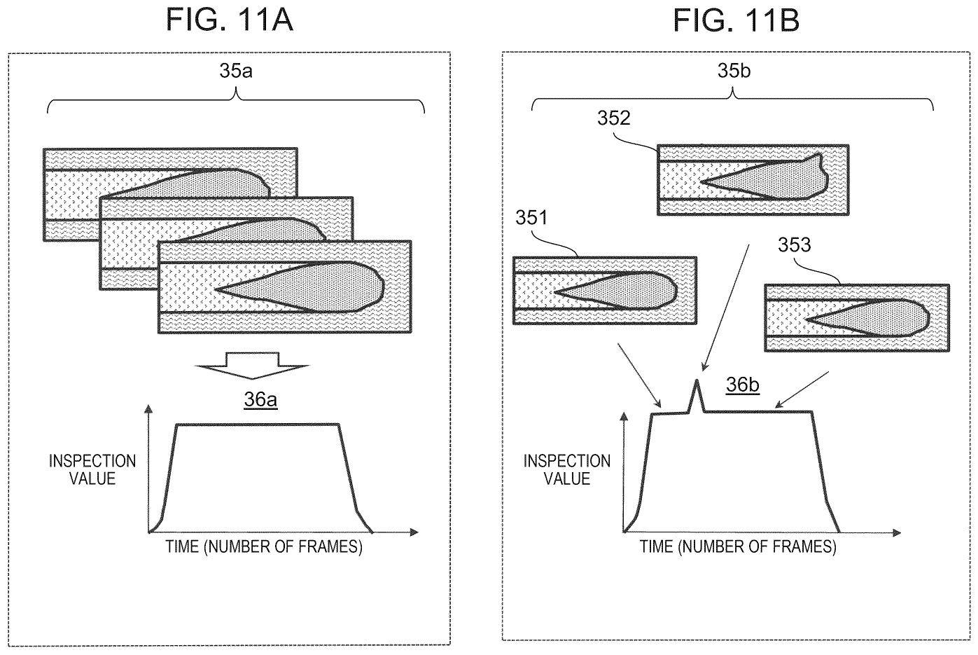

Processing state determiner 15 determines various welding states such as a processing state of the molten pool based on the calculated time-series inspection values (S24). FIGS. 11A and 11B are diagrams for describing the processing (S24) of determining the welding state by a time-series change in the inspection values for the time-series continuous image into which the inspection region is classified according to inspection device 1c of the present exemplary embodiment.

FIG. 11A illustrates time-series continuous image 35a including a plurality of frame images captured as molten pool images during one time of welding in a normal welding state, and time-series graph 36a obtained by graphing a relationship between an inspection value calculated from continuous image 35a and a time at which each frame is captured (that is, the number of frames).

FIG. 11B illustrates continuous image 35b when an abnormality occurs in the welding state during one time of welding, and time-series graph 36b corresponding to a time change in an inspection value calculated from continuous image 35b. In inspection device 1c of the present exemplary embodiment, the inspection region to be classified by region classifier 13 includes molten pool region 21a. In FIG. 11B, time-series graph 36b indicates, for example, a time change in an area of molten pool region 21a as an inspection value. In the example of FIG. 11B, among the frame images 351 to 353 included in continuous image 35b, the shape of the molten pool becomes abnormal when frame image 352 is captured, and the inspection value changes steeply and becomes unstable in the time corresponding to frame image 352.

In step S24, for example, based on the molten pool area of the inspection value calculated from each frame image at one time of welding in step S23, in a case where a variation amount of the molten pool area in time series is a predetermined value or more, processing state determiner 15 determines that the abnormality has occurred at the time of welding. For example, the variation amount in time series may be calculated as a standard deviation using an average value calculated from the inspection value for each frame in a period in which the inspection value is equal to or greater than a predetermined threshold value in the period in which each frame image is captured. The predetermined value of the variation amount for such an area is determined experimentally and may be, for example, 1 square millimeter (mm²).

The inspection value is not limited to the molten pool area, and for example, a width in the lateral direction (for example, Y direction in FIG. 11) and/or a length in the longitudinal direction (for example, X direction in FIG. 11), that is, the tail length, of molten pool region 21a may be calculated and used for the determination of the welding state. In addition, the inspection region may include keyhole region 26 in addition to or instead of molten pool region 21a, and for example, similarly to the above example, the welding state of molten pool 21 can be determined using the keyhole area and the like as the inspection value. Furthermore, the welding state may be determined using the bead width of post-solidification bead region 27 as the inspection value.

According to the processing described above, in inspection device 1c, the image data of the molten pool image during welding of workpiece M1 is acquired (S21), the region classification is executed by region classifier 13 for each frame of the molten pool image (S22), and thereafter the inspection value is calculated for the classified inspection region (S23). According to processing state determiner 15 of inspection device 1c, various welding states such as the processing state of molten pool 21 are determined based on the calculated inspection value (S24). For example, in the molten pool image acquired by in-process at the time of laser welding, region classifier 13 generated using the mask data by learning device 50 described above can accurately perform the region classification for detecting the inspection region in units of pixels. As a result, it is possible to easily calculate the inspection value corresponding to the feature of the inspection region, and to accurately inspect the welding state based on the inspection value.

In step S24 described above, the example has been described in which the welding state is determined for molten pool region 21a and/or keyhole region 26. The inspection region of inspection device 1c may include perforated region 28. In this case, for example, processing state determiner 15 may calculate an inspection value indicating whether perforated region 28 is present from each frame image (S23), and determine the quality of molten pool 21 at the time of welding when the image is acquired based on whether perforated region 28 is present. For example, when perforated region 28 is not present, molten pool 21 may be determined to be in a good state.

### 2-2-1. Optimization Processing of Processing Conditions

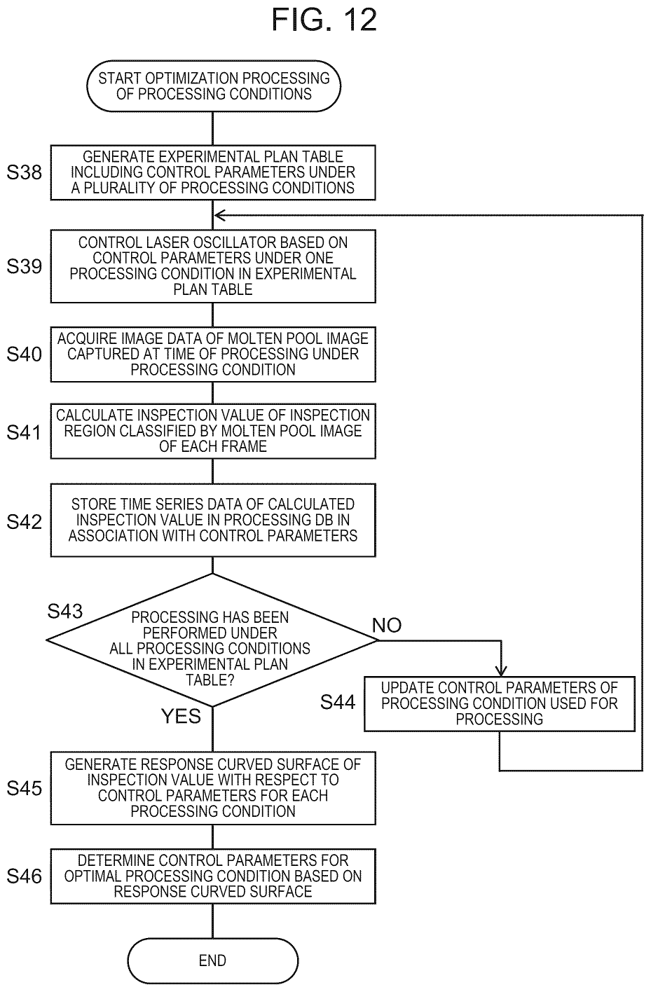

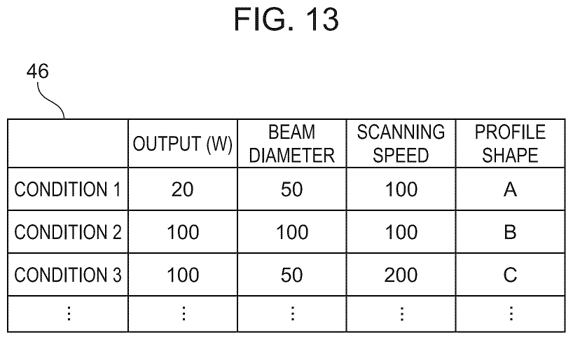

Welding system 1 of the present exemplary embodiment can accurately calculate the inspection value from the molten pool image by the operation of inspection device 1c as described above. Inspection device 1c according to the present exemplary embodiment further calculates, in time series, the inspection values at the time of welding under each processing condition in the plurality of processing conditions by the operation, and derives the optimal processing condition that minimizes the variation in the inspection values during welding. Hereinafter, such an operation of inspection device 1c for implementing an optimal processing process will be described with reference to FIGS. 12 and 13.

FIG. 12 is a flowchart indicating processing of optimizing a control parameter corresponding to a processing condition of laser welding according to inspection device 1c of the present exemplary embodiment. The processing in this flowchart is started in a state where, for example, a range, a candidate, or the like of a value that can be set for a control parameter of the laser processing machine in welding system 1 is stored in processing DB 14 of inspection device 1c. Each piece of processing in this flowchart is executed by arithmetic circuit 62 of inspection device 1c.

First, for example, arithmetic circuit 62 refers to processing DB 14 as processing controller 16, and generates an experimental plan table for managing control parameters for each processing condition under a plurality of processing conditions (S38). FIG. 13 illustrates experimental plan table 46 at the time of processing in welding system 1 of the present exemplary embodiment. As illustrated in FIG. 13, processing controller 16 generates experimental plan table 46 in which at least one of the laser output, the beam diameter, the scanning speed, and the profile shape in laser welding in welding system 1, as control parameters for each processing condition, is changed. In the example of FIG. 13, the unit of the laser output is watt (W).

Next, arithmetic circuit 62 as processing controller 16 controls laser oscillator 17 based on, for example, control parameters of one processing condition in generated experimental plan table 46 (S39). As a result, processing for laser welding workpiece M1 is performed under the processing condition. In welding system 1 of the present exemplary embodiment, the molten pool image is captured by high-speed camera 11 during such processing.

Similarly to step S21 (FIG. 10), for example, arithmetic circuit 62 acquires, from high-speed camera 11, image data of the molten pool image captured at the time of processing under the processing condition for which processing has been performed under the control of step S39 (S40). Arithmetic circuit 62 may perform processing of dividing the time-series molten pool image for each frame on the acquired image data.

Similarly to steps S22 and S23 (FIG. 10), for example, arithmetic circuit 62 executes region classification on the molten pool image of each frame by region classifier 13, and calculates an inspection value for the classified inspection region as processing state determiner 15 (S41).

Arithmetic circuit 62 stores the time-series data of the inspection value calculated for each frame of the molten pool image in processing DB 14 in association with the control parameters of the processing condition under which the processing is performed in step S39 (S42).

Arithmetic circuit 62 refers to experimental plan table 46 and determines whether processing under all processing conditions in experimental plan table 46 has been performed, that is, whether laser oscillator 17 has been controlled by the control parameters of each processing condition (S43).

In a case where the processing is not performed under all processing conditions (NO in S43), arithmetic circuit 62 updates, from experimental plan table 46, the control parameter used for processing under the control of laser oscillator 17 to a control parameter under a processing condition different from the processing condition under which processing is performed (S44). Thereafter, arithmetic circuit 62 returns to step S39 and controls laser oscillator 17 based on the updated control parameter. In this manner, the processing of steps S39 to S44 is repeatedly executed until processing is performed under all processing conditions in experimental plan table 46.

In a case where the processing is performed under all the processing conditions in the experimental plan table (YES in S43), for example, arithmetic circuit 62 refers to experimental plan table 46 in processing DB 14 as processing state determiner 15, and generates a response curved surface of the inspection value calculated under the processing condition with respect to the control parameters for each processing condition (S45).

Arithmetic circuit 62 as processing state determiner 15 determines control parameters for an optimal processing condition among the plurality of processing conditions in experimental plan table 46 by performing, for example, multi-objective optimization processing based on the response curved surface obtained in step S45 (S46). For example, processing state determiner 15 determines, as an optimal processing condition, a processing condition in which a change in the inspection values in time series at the time of processing under each processing condition is the most stable among the plurality of processing conditions. Processing state determiner 15 may calculate the standard deviation of the inspection values in a predetermined period at each time of processing and determine the processing condition with the minimum standard deviation as the most stable processing condition.

In addition, for example, by measuring a penetration depth, a welding intensity, and the like of workpiece M1 at each time of processing after processing and storing them in association with the processing condition at the time of processing, it is possible to determine the optimal processing condition in the processing of step S46 from the processing conditions under which desired penetration depth and welding intensity can be obtained as processing performance.

According to the processing described above, experimental plan table 46 including the control parameters corresponding to the plurality of processing conditions is generated (S38), and the inspection values are calculated for the inspection region classified by region classifier 13 from the molten pool image at the time of processing under each processing condition (S39 to S41). Further, by generating the response curved surface of the inspection values calculated with respect to the control parameters for each processing condition (S45), the control parameters of the optimal processing condition, such as a stable change in the inspection values in time series for obtaining desired processing performance, is determined from the response curved surface (S46). As described above, the influence of the control parameters of each processing condition on processing can be automatically organized as the response curved surface of the inspection values based on the experimental plan method using experimental plan table 46, and for example, the control parameters of the optimal processing condition for desired processing performance can be easily determined.

### 3. Effects and Others

As described above, in the present exemplary embodiment, learning device 50 constructs, by machine learning, region classifier 13 as an example of an image recognizer used for inspection of a welding state by image recognition of workpiece M1 processed in laser welding (S11 to S15). Learning device 50 includes image acquisition unit 51a, image processor 52a, and a learning unit 52b. Image acquisition unit 51a acquires a molten pool image as an example of an image captured by irradiating workpiece M1 with light having an infrared wavelength so as to include a region of molten pool 21 generated by phase transformation of workpiece M1 from solid to liquid during processing (S11). Image processor 52a sets a boundary line between the inspection region and other region in the molten pool image based on the luminance of the molten pool image (S12, S13). Learning unit 52b constructs region classifier 13 by machine learning so as to identify the inspection region in the molten pool image (S15). The inspection region indicates at least one of region 21a of molten pool 21 and regions 26, 27, 28 formed inside or near molten pool 21 on workpiece M1 by laser welding in the molten pool image. Learning unit 52b generates region classifier 13 based on the training data including the molten pool image and the mask data as an example of the identification information for identifying the inspection region and other region by the boundary line in the molten pool image, in association with each other (S14, S15).

According to learning device 50 described above, by setting the boundary line between the inspection region and other region based on the luminance in the molten pool image (S12, S13), region classifier 13 can be constructed by machine learning based on the training data including the highly accurate mask data of the inspection region (S14, S15). As a result, it is possible to accurately inspect the welding state by generated region classifier 13.

In the present exemplary embodiment, in the molten pool image, image processor 52a generates a luminance profile indicating a change in luminance for each pixel on a straight line crossing or traversing the image (S12), and sets a boundary line based on a change amount of luminance values between adjacent pixels among pixels included in the luminance profile (S13). As a result, it is possible to accurately set the boundary line for identifying the inspection region and other region.

In the present exemplary embodiment, as illustrated in parts (a) and (b) of FIG. 6, image processor 52a sets boundary line 25 between region 21a of the molten pool as the inspection region and other region such that boundary line 25 passes between the pixels in which the change amount of the luminance values is the first value or more (S13). For example, in the present exemplary embodiment, the first value is “20”.

In the present exemplary embodiment, as illustrated in parts (a) and (b) of FIG. 6, image processor 52a generates a plurality of luminance profiles 22 (S12), and calculates, as boundary line 25, a line that connects boundaries between pixels in which the change amount of the luminance values between adjacent pixels of each luminance profile 22 is the first value or more in the plurality of luminance profiles 22 (S13). As a result, it is possible to accurately calculate boundary line 25 using the plurality of luminance profiles 22.

In the present exemplary embodiment, image processor 52a further sets, in the molten pool image, a boundary line between regions 26, 27, 28 generated or changed due to a welding defect of workpiece M1, as the inspection regions, and other region (S13) (see FIG. 8A). Also in this case, it is possible to accurately extract each of regions 26, 27, 28 by the boundary lines set similarly to the case of weld pool region 21a.

In the present exemplary embodiment, inside the boundary line of molten pool 21, image processor 52a sets a boundary line between keyhole region 26 indicating a keyhole formed on workpiece M1 by the laser welding and other region such that the boundary line passes between the pixels in which the change amount of the luminance values is the second value (S13). In the present exemplary embodiment, the second value is larger than the first value. As a result, according to the fact that keyhole region 26 irradiated with the laser light 7 on workpiece M1 becomes a region having much higher luminance than the surrounding region in the molten pool image, it is possible to accurately set the boundary line.

In the present exemplary embodiment, outside the boundary line of molten pool 21, image processor 52a sets a boundary line between perforated region 28 indicating a perforation formed on workpiece M1 by the laser welding and other region such that the boundary line passes between the pixels in which the change amount of the luminance values is the second value (S13), and the second value is larger than the first value. As a result, according to the fact that perforated region 28 becomes a region much darker than the surroundings in the molten pool image due to the hole being formed in workpiece M1, it is possible to accurately set the boundary line. For example, in the present exemplary embodiment, the second value is “50” larger than the first value “20”.

In the present exemplary embodiment, inspection device 1c that inspects a welding state of workpiece M1 to be processed in laser welding includes region classifier 13 as an example of an image recognizer generated by learning device 50, and processing state determiner 15 as an example of an inspection unit that calculates an inspection value quantitatively indicating a welding state in the inspection region based on a recognition result by region classifier 13 in an image different from a molten pool image under a photographing condition similar to that acquired by learning device 50, for example. According to such inspection device 1c, it is possible to accurately inspect the welding state using region classifier 13 generated by learning device 50.

In the present exemplary embodiment, inspection device 1c inspects the welding state of workpiece M1 processed in the laser welding (S21 to S24). Inspection device 1c includes image acquisition unit 12, region classifier 13 as an example of an image recognizer, and processing state determiner 15 as an example of an inspection unit. Image acquisition unit 12 acquires a molten pool image as an example of an image captured by irradiating workpiece M1 with light having an infrared wavelength so as to include a region of molten pool 21 generated by phase transformation of workpiece M1 from solid to liquid during processing (S21). Region classifier 13 identifies the inspection region and other region in the molten pool image by image recognition of the molten pool image (S22). Processing state determiner 15 calculates an inspection value quantitatively indicating the welding state in the inspection region based on the recognition result by region classifier 13 (S23). The inspection region indicates at least one of region 21a of molten pool 21 and regions 26, 27, 28 formed inside or near molten pool 21 on workpiece M1 by laser welding in the molten pool image. Region classifier 13 is generated by machine learning based on training data including a training image captured with the capturing condition same as the molten pool image and mask data (an example of identification information) for identifying the inspection region and other region in the training image, in association with each other (S11 to S15). The mask data is given by the boundary line set between the inspection region and other region in the training image (S13, S14).

According to inspection device 1c described above, by accurately identifying the inspection region and other region in the molten pool image by region classifier 13 (S22) and calculating the inspection values of the inspection region (S23), it is possible to accurately inspect the welding state using the inspection values.

In the present exemplary embodiment, in the laser welding, image acquisition unit 12 acquires a plurality of time-series continuous images, each of which is captured so as to include the region of molten pool 21 (S21). Region classifier 13 includes a learned model (an example of a classifier) generated by machine learning so as to classify each pixel of the image into a predetermined region including the inspection region. The predetermined region includes a perforated region indicating a perforation formed on workpiece M1 by laser welding in the image. Processing state determiner 15 further determines the quality of molten pool 21 caused by the laser welding based on whether a region, which is classified as a perforated region by the learned model of region classifier 13 in each image of the plurality of images, is present (S24). In this way, it is possible to determine the quality of molten pool 21 according to, for example, whether the perforated region as the welding state is present.

In addition, in the present exemplary embodiment, the predetermined region includes at least one of keyhole region 26 indicating the keyhole formed on workpiece M1 by the laser welding and region 21a indicating molten pool 21 in the image. Processing state determiner 15 calculates, as the inspection value, at least one of the area, the width in the lateral direction, and the length in the longitudinal direction of the region classified as keyhole region 26 or region 21a of the molten pool by the learned model of region classifier 13 in each image of the plurality of images (S23), and determines that an abnormality has occurred in the laser welding in a case where the time-series variation amount of the inspection values calculated from each image is a predetermined value or more (S24). In this way, it is possible to determine the occurrence of abnormality according to, for example, the time-series change in the size of keyhole region 26 or region 21a of the molten pool during the welding processing as the welding state.

For example, in the present exemplary embodiment, processing state determiner 15 calculates the variation amount in time series based on the average and the standard deviation of the inspection values between the times in the period in which the plurality of images is captured (S24). In addition, in the present exemplary embodiment, the inspection value includes the area of the classified region, and the predetermined value for the area of the classified region is 1 square millimeter (mm²).

In the present exemplary embodiment, welding system 1 is an example of a laser welding device that emits laser light according to a specified control parameter and performs welding processing of workpiece M1. Welding system 1 includes inspection device 1c, laser oscillator 17 (an example of an irradiator) that emits laser light 7 to workpiece M1 according to a specified control parameter, high-speed camera 11 (an example of a camera) that captures an image of workpiece M1 being processed by laser light 7 so as to include region 21a of molten pool 21 and generates image data indicating the captured image, and processing DB 14 that stores the control parameter. In the welding processing with the control parameter, high-speed camera 11 captures a molten pool image for each frame as an example of a plurality of time-series continuous images such that each molten pool image includes region 21a of molten pool 21. In inspection device 1c, region classifier 13 (an example of an image recognizer) includes a learned model (an example of a classifier) generated by machine learning so as to classify each pixel of the image into a predetermined region including the inspection region, processing state determiner 15 (an example of an inspection unit) calculates the inspection value in the inspection area classified by the classifier in each image of the plurality of images (S41), and processing DB 14 stores the inspection value calculated by processing state determiner 15 in association with the control parameter (S42). As a result, it is possible to accumulate, in processing DB 14, for example, the respective inspection values calculated from the time-series images being processed and the control parameters at the time of processing with which the plurality of images is obtained in association with each other.

In the present exemplary embodiment, the inspection region includes, in the molten pool image, at least one of regions 21a, 26, 28, 29, 27 indicating molten pool 21 on workpiece M1, a keyhole or perforation formed by welding processing, an unprocessed portion outside molten pool 21, and a post-solidification bead obtained by solidifying molten pool 21, respectively. Region classifier 13 of inspection device 1c inputs each image to the classifier, and outputs images that are classified into predetermined regions in pixel units of each image and are continuous in time series in the welding processing with the control parameters. In this way, for example, in the molten pool image for each frame, it is possible to extract each inspection region by region classifier 13.

In the present exemplary embodiment, processing DB 14 stores control parameters that specify each of a plurality of processing conditions to laser oscillator 17. Welding system 1 further includes a processing controller 16 (an example of a controller) that controls laser oscillator 17 based on the control parameters of each processing condition under the plurality of processing conditions. Processing controller 16 causes laser oscillator 17 to emit laser light 7 so as to perform the welding processing with the control parameters of each processing condition (S39). In the welding processing with the control parameter of each processing condition, processing state determiner 15 calculates the inspection value in the inspection region based on the image data of each image in time series output by region classifier 13 (S41), generates a response curved surface of the inspection value calculated from the image under each processing condition with respect to the control parameters of each processing condition (S45), and determines the processing condition with the minimum variation amount in time series of the inspection values among the plurality of processing conditions by the optimization using the response curved surface (S46). As a result, it is possible to determine the optimal processing condition based on, for example, a predetermined criterion such as the stability of laser welding.

### Other Exemplary Embodiments

As described above, the first exemplary embodiment has been described as an example of the technique disclosed in the present application. However, the technique in the present disclosure is not limited thereto, and may also be applied to exemplary embodiments in which changes, replacements, additions, omissions, or the like are made as appropriate. Hereinafter, other exemplary embodiments will be described as examples.

In the first exemplary embodiment described above, the example in which inspection device 1c includes processing DB 14 and processing controller 16 in welding system 1 has been described. In the present exemplary embodiment, processing DB 14 and processing controller 16 may be provided, for example, in an external information processing device capable of performing data communication with inspection device 1c. In addition, processing DB 14 and processing controller 16 may be provided in the same information processing device, or may be provided in different information processing devices.

In the exemplary embodiment described above, the example in which inspection device 1c and learning device 50 are implemented by different computers in welding system 1 has been described. In the present exemplary embodiment, inspection device 1c and learning device 50 may be integrally configured, or may be implemented by one computer, for example.

In the exemplary embodiment described above, the example in which laser oscillator 17 performs laser oscillation at the wavelength λ of 1070 nm in welding system 1 has been described. In the present exemplary embodiment, a wavelength of laser light emitted from laser oscillator 17 is not limited to the above example, and may be in the range of 266 nm to 11 um where laser welding can be performed. In this case, an optical system or the like corresponding to the wavelength of the laser light may be appropriately used in welding system 1. In addition, a laser oscillator of a type different from the example of the first exemplary embodiment may be used.

In the exemplary embodiment described above, the example in which inspection device 1c determines the control parameters of the processing condition by multi-objective optimization in the optimization processing of the processing conditions (FIG. 12) has been described (S46). In the present exemplary embodiment, determination of control parameters in optimization processing of processing conditions is not limited to multi-objective optimization, and may be executed using various optimization algorithms such as Bayesian optimization or reinforcement learning.

The present disclosure is not limited to the exemplary embodiments described above, and various modifications can be made. That is, exemplary embodiments obtained by combining technical means suitably modified by those skilled in the art also fall within the scope of the present disclosure.

### (Aspects of Present Disclosure)

As described above, the present disclosure includes the following aspects.

### (First Aspect)

A learning device that constructs, by machine learning, an image recognizer used for inspection of a welding state by image recognition of a workpiece to be processed in laser welding, the learning device including:
an image acquisition unit that acquires an image photographed by irradiating the workpiece with light having an infrared wavelength, the image including a region of a molten pool generated by phase transformation of the workpiece from solid to liquid during processing;
an image processor that sets a boundary line between an inspection region and another region in the image based on luminance of the image; and
a learning unit that constructs the image recognizer by machine learning to identify the inspection region in the image, in which
in the image, the inspection region indicates at least one of a region of the molten pool, and regions formed inside or near the molten pool on the workpiece by the laser welding, and
the learning unit generates the image recognizer based on training data including
   the image, and
   identification information for identifying the inspection region and another region by the boundary line in the image, in association with each other.

### (Second Aspect)

The learning device according to the first aspect, in which in the image, the image processor generates a luminance profile indicating a change in luminance for each pixel on a straight line crossing or traversing the image, and sets the boundary line based on a change amount of luminance values between adjacent pixels among pixels included in the luminance profile.

### (Third Aspect)

The learning device according to the second aspect, in which the image processor sets a boundary line between a region of the molten pool, as the inspection region, and another region, the boundary line passing between pixels in which a change amount of the luminance values is a first value or more.

### (Fourth Aspect)

The learning device according to the third aspect, in which the first value is 20.

### (Fifth Aspect)

The learning device according to the third aspect or the fourth aspect, in which the image processor generates a plurality of the luminance profiles, and calculates, as the boundary line, a line connecting boundaries between pixels in which a change amount of the luminance values between the adjacent pixels of each luminance profile is the first value or more in the plurality of luminance profiles.

### (Sixth Aspect)

The learning device according to any one of the second aspect to fifth aspect, in which the image processor further sets, in the image, a boundary line between a region generated or changed due to a welding defect of the workpiece, as the inspection region, and another region.

### (Seventh Aspect)

The learning device according to the sixth aspect, in which
inside a boundary line of the molten pool, the image processor sets a boundary line between a region indicating a keyhole formed on the workpiece by the laser welding and another region, the boundary line passing between pixels in which a change amount of the luminance values is a second value, and
the second value is larger than the first value.

### (Eighth Aspect)

The learning device according to the sixth aspect or the seventh aspect, in which
outside a boundary line of the molten pool, the image processor sets a boundary line between a region indicating a perforation formed on the workpiece by the laser welding and another region, the boundary line passing between pixels in which a change amount of the luminance values is a second value, and
the second value is larger than the first value.

### (Ninth Aspect)

The learning device according to the seventh aspect or the eighth aspect, in which the second value is 50.

### (Tenth Aspect)

An inspection device that inspects a welding state of a workpiece to be processed in laser welding, the inspection device including:
the image recognizer generated by the learning device according to any one of the first aspect to ninth aspect; and
an inspection unit that calculates an inspection value quantitatively indicating a welding state in the inspection region based on a recognition result by the image recognizer in an image different from the image under a photographing condition similar to that of the image.

### (Eleventh Aspect)

An inspection device that inspects a welding state of a workpiece to be processed in laser welding, the inspection device including:
an image acquisition unit that acquires an image photographed by irradiating the workpiece with light having an infrared wavelength, the image including a region of a molten pool generated by phase transformation of the workpiece from solid to liquid during processing;
an image recognizer that identifies an inspection region and another region in the image by image recognition of the image; and
an inspection unit that calculates an inspection value quantitatively indicating a welding state in the inspection region based on a recognition result by the image recognizer, in which
in the image, the inspection region indicates at least one of a region of the molten pool, and regions formed inside or near the molten pool on the workpiece by the laser welding,
the image recognizer is generated by machine learning based on training data including
   a training image photographed under a photographing condition same as the image, and
   identification information for identifying the inspection region and another region in the training image, in association with each other, and
the identification information is given by a boundary line set between the inspection region and another region in the training image.

### (Twelfth Aspect)

The inspection device according to the eleventh aspect, in which
in the laser welding, the image acquisition unit acquires a plurality of time-series continuous images each being photographed, the plurality of time-series continuous images including a region of the molten pool,
the image recognizer includes a classifier generated by machine learning, the classifier being configured to classify each pixel of an image into a predetermined region including the inspection region,
the predetermined region includes, in an image, a perforated region indicating a perforation formed on the workpiece by the laser welding, and
the inspection unit further determines a quality of the molten pool by the laser welding based on whether a region classified as the perforated region by the classifier is present in each image of the plurality of time-series continuous images.

### (Thirteenth Aspect)

The inspection device according to the eleventh aspect or the twelfth aspect, in which
in the laser welding, the image acquisition unit acquires a plurality of time-series continuous images each being photographed, the plurality of time-series continuous images including a region of the molten pool,
the image recognizer includes a classifier generated by machine learning, the classifier being configured to classify each pixel of an image into a predetermined region including the inspection region,
the predetermined region includes, in an image, at least one of a keyhole region indicating a keyhole formed on the workpiece by the laser welding and a region indicating the molten pool, and
the inspection unit
   calculates, as the inspection value, at least one of an area, a width in a lateral direction, and a length in a longitudinal direction of a region classified into the keyhole region or a region of the molten pool by the classifier in each image of the plurality of time-series continuous images, and
   determines that an abnormality has occurred in the laser welding in a case where a variation amount in time series of the inspection value calculated from each image is a predetermined value or more.

### (Fourteenth Aspect)

The inspection device according to the thirteenth aspect, in which the inspection unit calculates the variation amount in time series based on an average and a standard deviation of the inspection values between times in a period in which the plurality of time-series continuous images is photographed.

### (Fifteenth Aspect)

The inspection device according to the thirteenth aspect or the fourteenth aspect, in which
the inspection value includes an area of the classified region, and
the predetermined value for the area of the classified region is 1 square millimeter (mm²).

### (Sixteenth Aspect)

A laser welding device that emits laser light according to a specified control parameter and performs welding processing of a workpiece, the laser welding device including:
the inspection device according to any one of the eleventh aspect to fifteenth aspect;
an irradiator that emits laser light to the workpiece according to the control parameter;
a camera that captures an image of the workpiece being processed by the laser light, the image including a region of the molten pool, and generates image data indicating the captured image; and
a processing database that stores the control parameter, in which
in welding processing with the control parameter, the camera captures a plurality of time-series continuous images, each image including a region of the molten pool,
in the inspection device,
   the image recognizer includes a classifier generated by machine learning, the classifier being configured to classify each pixel of an image into a predetermined region including the inspection region,
   the inspection unit calculates the inspection value in the inspection region classified by the classifier in each image of the plurality of time-series continuous images, and
the processing database stores the inspection value calculated by the inspection unit in association with the control parameter.

### (Seventeenth Aspect)

The laser welding device according to the sixteenth aspect, in which
in an image, the inspection region includes at least one of regions indicating respective one of the molten pool on the workpiece, a keyhole or perforation formed by the welding process, an unprocessed portion outside the molten pool, and a post-solidification bead obtained by solidifying the molten pool, and
the image recognizer of the inspection device inputs each image to the classifier, and outputs images that are classified into the predetermined region in pixel units of each image and are continuous in time series in welding processing with the control parameter.

### (Eighteenth Aspect)

The laser welding device according to the seventeenth aspect, in which
the processing database stores a control parameter that specifies each of a plurality of processing conditions to the irradiator,
the laser welding device further includes a controller that controls the irradiator based on a control parameter of each processing condition in the plurality of processing conditions,
the controller causes the irradiator to emit laser light to perform the welding processing under the control parameter of each processing condition, and
the inspection unit
   calculates the inspection value in the inspection region based on image data of each image in time series output from the image recognizer in welding processing by the control parameter of each processing condition,
   generates a response curved surface of the inspection value calculated from an image under each processing condition with respect to the control parameter of each processing condition, and
   determines a processing condition having a minimum variation amount in time series of the inspection value among the plurality of processing conditions by optimization using the response curved surface.

### INDUSTRIAL APPLICABILITY

A learning device of the present disclosure is applicable to a technique of creating teacher data for accurately classifying a region such as a molten pool by region classification using machine learning in an image obtained by visualizing the molten pool formed on a workpiece at the time of laser welding by IR illumination. In addition, an inspection device of the present disclosure is applicable to a technique of detecting the inspection region such as the molten pool from an image of the workpiece at the time of welding and monitoring a welding state by using such a machine learning model of the region classification based on the teacher data. For example, in a welding process of a lithium ion secondary battery as a workpiece, the inspection device of the present disclosure can be used to determine whether a product is good or defective at the time of laser welding.

Furthermore, the inspection device of the present disclosure is also applicable to determination of an optimal processing condition corresponding to a workpiece such as a device to be inspected by using optimization methods of the processing conditions in combination. In addition, the type of the device of the workpiece to which the technique of the present disclosure is applied is not particularly limited, and the technique is applicable to various devices such as a nickel-metal hydride battery, a nickel-cadmium battery, a rectangular secondary battery, or a primary battery in addition to a lithium ion secondary battery. Furthermore, the technique of the present disclosure can also be used at the time of welding a device such as an EV motor.

1. A learning device that constructs, by machine learning, an image recognizer used for inspection of a welding state by image recognition of a workpiece to be processed in laser welding, the learning device comprising:
an image acquisition unit that acquires an image photographed by irradiating the workpiece with light having an infrared wavelength, the image including a region of a molten pool generated by phase transformation of the workpiece from solid to liquid during processing;
an image processor that sets a boundary line between an inspection region and another region in the image based on luminance of the image; and
a learning unit that constructs the image recognizer by machine learning to identify the inspection region in the image, wherein
in the image, the inspection region indicates at least one of a region of the molten pool, and regions formed inside or near the molten pool on the workpiece by the laser welding, and
the learning unit generates the image recognizer based on training data including
the image, and
identification information for identifying the inspection region and another region by the boundary line in the image, in association with each other.

2. The learning device according to claim 1, wherein in the image, the image processor generates a luminance profile indicating a change in luminance for each pixel on a straight line crossing or traversing the image, and sets the boundary line based on a change amount of luminance values between adjacent pixels among pixels included in the luminance profile.

3. The learning device according to claim 2, wherein the image processor sets a boundary line between a region of the molten pool, as the inspection region, and another region, the boundary line passing between pixels in which a change amount of the luminance values is a first value or more.

4. The learning device according to claim 3, wherein the first value is 20.

5. The learning device according to claim 3, wherein the image processor generates a plurality of the luminance profiles, and calculates, as the boundary line, a line connecting boundaries between pixels in which a change amount of the luminance values between the adjacent pixels of each luminance profile is the first value or more in the plurality of luminance profiles.

6. The learning device according to claim 2, wherein the image processor further sets, in the image, a boundary line between a region generated or changed due to a welding defect of the workpiece, as the inspection region, and another region.

7. The learning device according to claim 6, wherein
inside a boundary line of the molten pool, the image processor sets a boundary line between a region indicating a keyhole formed on the workpiece by the laser welding and another region, the boundary line passing between pixels in which a change amount of the luminance values is a second value, and
the second value is larger than the first value.

8. The learning device according to claim 6, wherein
outside a boundary line of the molten pool, the image processor sets a boundary line between a region indicating a perforation formed on the workpiece by the laser welding and another region, the boundary line passing between pixels in which a change amount of the luminance values is a second value, and
the second value is larger than the first value.

9. The learning device according to claim 7, wherein the second value is 50.

10. An inspection device that inspects a welding state of a workpiece to be processed in laser welding, the inspection device comprising:
the image recognizer generated by the learning device according to claim 1; and
an inspection unit that calculates an inspection value quantitatively indicating a welding state in the inspection region based on a recognition result by the image recognizer in an image different from the image under a photographing condition similar to that of the image.

11. An inspection device that inspects a welding state of a workpiece to be processed in laser welding, the inspection device comprising:
an image acquisition unit that acquires an image photographed by irradiating the workpiece with light having an infrared wavelength, the image including a region of a molten pool generated by phase transformation of the workpiece from solid to liquid during processing;
an image recognizer that identifies an inspection region and another region in the image by image recognition of the image; and
an inspection unit that calculates an inspection value quantitatively indicating a welding state in the inspection region based on a recognition result by the image recognizer, wherein
in the image, the inspection region indicates at least one of a region of the molten pool, and regions formed inside or near the molten pool on the workpiece by the laser welding,
the image recognizer is generated by machine learning based on training data including
a training image photographed under a photographing condition same as the image, and
identification information for identifying the inspection region and another region in the training image, in association with each other, and
the identification information is given by a boundary line set between the inspection region and another region in the training image.

12. The inspection device according to claim 11, wherein
in the laser welding, the image acquisition unit acquires a plurality of time-series continuous images each being photographed, the plurality of time-series continuous images including a region of the molten pool,
the image recognizer includes a classifier generated by machine learning, the classifier being configured to classify each pixel of an image into a predetermined region including the inspection region,
the predetermined region includes, in an image, a perforated region indicating a perforation formed on the workpiece by the laser welding, and
the inspection unit further determines a quality of the molten pool by the laser welding based on whether a region classified as the perforated region by the classifier is present in each image of the plurality of time-series continuous images.

13. The inspection device according to claim 11, wherein
in the laser welding, the image acquisition unit acquires a plurality of time-series continuous images each being photographed, the plurality of time-series continuous images including a region of the molten pool,
the image recognizer includes a classifier generated by machine learning, the classifier being configured to classify each pixel of an image into a predetermined region including the inspection region,
the predetermined region includes, in an image, at least one of a keyhole region indicating a keyhole formed on the workpiece by the laser welding and a region indicating the molten pool, and
the inspection unit
calculates, as the inspection value, at least one of an area, a width in a lateral direction, and a length in a longitudinal direction of a region classified into the keyhole region or a region of the molten pool by the classifier in each image of the plurality of time-series continuous images, and
determines that an abnormality has occurred in the laser welding in a case where a variation amount in time series of the inspection value calculated from each image is a predetermined value or more.

14. The inspection device according to claim 13, wherein the inspection unit calculates the variation amount in time series based on an average and a standard deviation of the inspection values between times in a period in which the plurality of time-series continuous images is photographed.

15. The inspection device according to claim 13, wherein
the inspection value includes an area of the classified region, and
the predetermined value for the area of the classified region is 1 square millimeter (mm²).

16. A laser welding device that emits laser light according to a specified control parameter and performs welding processing of a workpiece, the laser welding device comprising:
the inspection device according to claim 11;
an irradiator that emits laser light to the workpiece according to the control parameter;
a camera that captures an image of the workpiece being processed by the laser light, the image including a region of the molten pool, and generates image data indicating the captured image; and
a processing database that stores the control parameter, wherein
in welding processing with the control parameter, the camera captures a plurality of time-series continuous images, each image including a region of the molten pool,
in the inspection device,
the image recognizer includes a classifier generated by machine learning, the classifier being configured to classify each pixel of an image into a predetermined region including the inspection region,
the inspection unit calculates the inspection value in the inspection region classified by the classifier in each image of the plurality of time-series continuous images, and
the processing database stores the inspection value calculated by the inspection unit in association with the control parameter.

17. The laser welding device according to claim 16, wherein
in an image, the inspection region includes at least one of regions indicating respective one of the molten pool on the workpiece, a keyhole or perforation formed by the welding process, an unprocessed portion outside the molten pool, and a post-solidification bead obtained by solidifying the molten pool, and
the image recognizer of the inspection device inputs each image to the classifier, and outputs images that are classified into the predetermined region in pixel units of each image and are continuous in time series in welding processing with the control parameter.

18. The laser welding device according to claim 17, wherein
the processing database stores a control parameter that specifies each of a plurality of processing conditions to the irradiator,
the laser welding device further includes a controller that controls the irradiator based on a control parameter of each processing condition in the plurality of processing conditions,
the controller causes the irradiator to emit laser light to perform the welding processing under the control parameter of each processing condition, and
the inspection unit
calculates the inspection value in the inspection region based on image data of each image in time series output from the image recognizer in welding processing by the control parameter of each processing condition,
generates a response curved surface of the inspection value calculated from an image under each processing condition with respect to the control parameter of each processing condition, and
determines a processing condition having a minimum variation amount in time series of the inspection value among the plurality of processing conditions by optimization using the response curved surface.
